(19) United States
(12) Patent Application Publication
(10) Pub. No.: US 2005/0162499 A1
(43) Pub. Date: Jul. 28, 2005

(54) Image forming device

(76) Inventors: Toshihiro Sugiyama, Tokyo (JP); Hiroshi Saitoh, Chiba (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/041,457

(22) Filed: Jan. 25, 2005

(30) Foreign Application Priority Data
Jan. 28, 2004 (JP) 2004-019820

(51) Int. Cl. B41J 2/385

(52) U.S. Cl. 347/118

(57) ABSTRACT

An image forming device includes a photosensitive body, an electrostatic charging device which electrostatically charges the photosensitive body, a light exposure device which image-light-exposes a moving surface of the photosensitive body so that an electrostatic latent image is formed on the photosensitive body, and a developing device which makes visible the electrostatic latent image as a toner image. The light exposure device forms a beam spot on the moving surface of the photosensitive body by selectively irradiating a light beam corresponding to image data in a state where parts of two beam spots neighboring each other in a sub scanning direction overlap each other in the sub scanning direction. A summation of light energies when the two beam spots are formed on the surface of the photosensitive body with a time interval is set to be smaller than a summation of light energies when two beam spots are simultaneously formed on the surface of the photosensitive body.

### BACKGROUND OF THE INVENTION

1. Field of the Invention

The present invention relates to image forming devices, and more specifically, to an image forming device whereby an electrostatically charged photosensitive body surface is image-exposed by a light exposure device so that an electrostatic latent image is formed on the photosensitive body and the electrostatic latent image is made visible as a toner image by a developing device.

2. Description of the Related Art

Image forming devices such as an electronic copier, printer, facsimile, or a multi-functional machine are well known. A device having a laser device or a light emitting diode device is used as a light exposure device. Such a light exposure device selectively irradiates a light beam on the moving surface of the photosensitive body corresponding to image data, so that a beam spot is formed on the surface of the photosensitive body and an electrostatic latent image is formed on the photosensitive body. A light beam is irradiated on the electrostatically charged photosensitive body surface. Toner is electrostatically adhered on the surface so that a toner image is formed. When the light beam is irradiated, the absolute value of the electric potential of the surface is decreased. The more depressed the electric potential is, the higher the image density of the visible toner image is.

Meanwhile, even if a light beam having the same light energy amount is irradiated on the photosensitive body surface, the electric potential of the surface of the photosensitive body after the light beam is irradiated may be different depending on the way of the irradiation. For example, the depression of the electric potential when a light beam having a certain amount of light energy is irradiated on the electrostatically charged photosensitive body surface only one time is different from the depression of the electric potential when a light beam having an amount of the light energy half of the above-mentioned light energy is irradiated on the same above-mentioned surface two times. In the latter case, the absolute value of the electric potential on the surface of the photosensitive body is depressed more. This is a phenomenon generally known as “reciprocal law failure”. See Japan-Laid Open Patent Published Application No. 2003-205642.

On the other hand, in the case of the above-mentioned image forming device, in order to improve the image quality of a completed toner image, beam spots are formed in a state where parts of two beam spots neighboring each other on the photosensitive body surface in a sub scanning direction overlap each other in the sub scanning direction. In this situation, there are two cases, namely a case where two beam spots neighboring each other on the photosensitive body surface in the sub scanning direction are simultaneously formed on the photosensitive body surface and a case where the above-mentioned beam spots are respectively formed with a time interval (separated by a time interval). For example, in cases where the light exposure device has a laser device having plural light sources and a polygon mirror having plural mirrors reflecting the light beams out-going from the light sources, when two light beams simultaneously out-going from two light sources of the laser device are simultaneously reflected on the same mirror surface of the polygon mirror so as to irradiate on the photosensitive body surface, two beam spots neighboring each other in the sub scanning direction are simultaneously formed on the photosensitive body surface. On the other hand, when the light beams out-going from two light sources of the laser device with a certain time interval are reflected respectively on different mirror surfaces of the polygon mirror and irradiates on photosensitive body surface, two beam spots neighboring each other on the photosensitive body surface in the sub scanning direction are formed with a time interval.

Due to the phenomenon of “reciprocal law failure”, the absolute value of the surface electric potential of a part where two beam spots neighboring each other in the sub scanning direction overlap in a case where the beam spots are formed with a time interval, is lower than the absolute value of the surface electric potential of a part where two beam spots neighboring each other in the sub scanning direction overlap in a case where the beam spots are simultaneously formed.

The absolute value of the surface electric potential of a part where two beam spots neighboring each other in the sub scanning direction overlap in a case where the beam spots are formed with a time interval is lower than the absolute value of the surface electric potential of a part where two beam spots neighboring each other in the sub scanning direction overlap in a case where the beam spots are simultaneously formed. Image density-in a case where this image is made visible as a toner image of the former is higher than the latter. It is a general condition that a part whose image density is high and a part whose image density is low are mixed in an actual toner image. Therefore, there is unevenness of the completed toner image and therefore image quality is degraded. Such a phenomenon gives a bigger influence as the resolution of the toner image is formed higher.

### SUMMARY OF THE INVENTION

Accordingly, it is a general object of the present invention to provide a novel and useful image forming device in which one or more of the problems described above are eliminated.

Another and more specific object of the present invention is to provide an image forming device whereby the above-discussed drawbacks of the related art can be eliminated or reduced with a simple structure.

The above objects of the present invention are achieved by an image forming device, including:

a photosensitive body;

an electrostatic charging device which electrostatically charges the photosensitive body;

a light exposure device which image-light-exposes a moving surface of the photosensitive body so that an electrostatic latent image is formed on the photosensitive body; and

a developing device which makes visible the electrostatic latent image as a toner image;

wherein the light exposure device forms a beam spot on the moving surface of the photosensitive body by selectively irradiating a light beam corresponding to image data in a state where parts of two beam spots neighboring each other in a sub scanning direction overlap each other in the sub scanning direction, and

a summation of light energies when the two beam spots are formed on the surface of the photosensitive body with a time interval is set to be smaller than a summation of light energies when two beam spots are simultaneously formed on the surface of the photosensitive body.

The above objects of the present invention are also achieved by an image forming device, including:

a photosensitive body;

an electrostatic charging device which electrostatically charges the photosensitive body;

a light exposure device which image-light-exposes a moving surface of the photosensitive body so that an electrostatic latent image is formed on the photosensitive body; and

a developing device which makes visible the electrostatic latent image as a toner image;

wherein the light exposure device includes:

a laser device having a plurality of light sources which respectively irradiate light beams;

a polygon mirror having a plurality of mirrors which reflects the light beam out-going from the light source; and

a driving device which rotates the polygon mirror;

wherein the light exposure device main-scans in order to form a beam spot on the moving surface of the photosensitive body by selectively irradiating, in a main scanning direction, a light beam which out-goes from the light source and which is reflected by the mirror of the polygon mirror, corresponding to image data, in a state where parts of two beam spots neighboring each other in a sub scanning direction overlap each other in the sub scanning direction, and

wherein a summation of light energies when the two beam spots are formed by the light beams reflected by different mirror surfaces of the polygon mirror is set to be smaller than a summation of light energies when the two beam spots are formed by the light beams simultaneously reflected by the same mirror surface of the polygon mirror.

The above objects of the present invention are also achieved by an image forming device, including:

a photosensitive body;

an electrostatic charging device which electrostatically charges the photosensitive body;

a light exposure device which image-light-exposes a moving surface of the photosensitive body so that an electrostatic latent image is formed on the photosensitive body; and

a developing device which makes visible the electrostatic latent image as a toner image;

wherein the light exposure device has a light emitting diode device including a plurality of steps of light emitting diode arrays where light emitting diodes to form the beam spots are arranged in a line shape in a main scanning direction of the photosensitive body surface,

wherein the light exposure device forms a beam spot on the moving surface of the photosensitive body by selectively irradiating a light beam corresponding to image data in a state where parts of two beam spots neighboring each other in a sub scanning direction overlap each other in the sub scanning direction, and

wherein a summation of light energies when the two beam spots are formed on the surface of the photosensitive body with a time interval is set to be smaller than a summation of light energies when two beam spots are simultaneously formed on the surface of the photosensitive body surface.

The above objects of the present invention are also achieved by an image forming device, including:

a photosensitive body;

an electrostatic charging device which electrostatically charges the photosensitive body;

a light exposure device which image-light-exposes a moving surface of the photosensitive body so that an electrostatic latent image is formed on the photosensitive body; and

a developing device which makes visible the electrostatic latent image as a toner image;

wherein the light exposure device forms a beam spot on the moving surface of the photosensitive body by selectively irradiating a light beam corresponding to image data in a state where parts of two beam spots neighboring each other in a sub scanning direction overlap each other in the sub scanning direction, and

a summation of the amount of the light energy when two beam spots neighboring in the sub scanning direction are formed on the surface of the photosensitive body is made lower, as a time difference with which the two beam spots are formed on the surface of the photosensitive body is larger.

Other objects, features, and advantages of the present invention will become more apparent from the following detailed description when read in conjunction with the accompanying drawings.

### BRIEF DESCRIPTION OF THE DRAWINGS

FIG. 1 is a partial cross-sectional schematic view of an example of an image forming device of the present invention;

FIG. 2 is a schematic view of a light exposure device;

FIG. 3 is an enlarged perspective view of a laser device;

FIG. 4 is a schematic view for explaining a positional relationship between a polygon mirror and a photosensitive body;

FIG. 5 is a view for explaining a beam spot formed on the photosensitive body;

FIG. 6 is a cross-sectional schematic view showing another example of the image forming device of the present invention;

FIG. 7 is a view seen from a side of a photosensitive body of a light emitting diode device shown in FIG. 6; and

FIG. 8 is an explanatory view showing a beam spot formed on the photosensitive body; and

FIG. 9 is a perspective view of a laser device from which four optical beams outgo.

### DETAILED DESCRIPTION OF THE PREFERED EMBODIMENTS

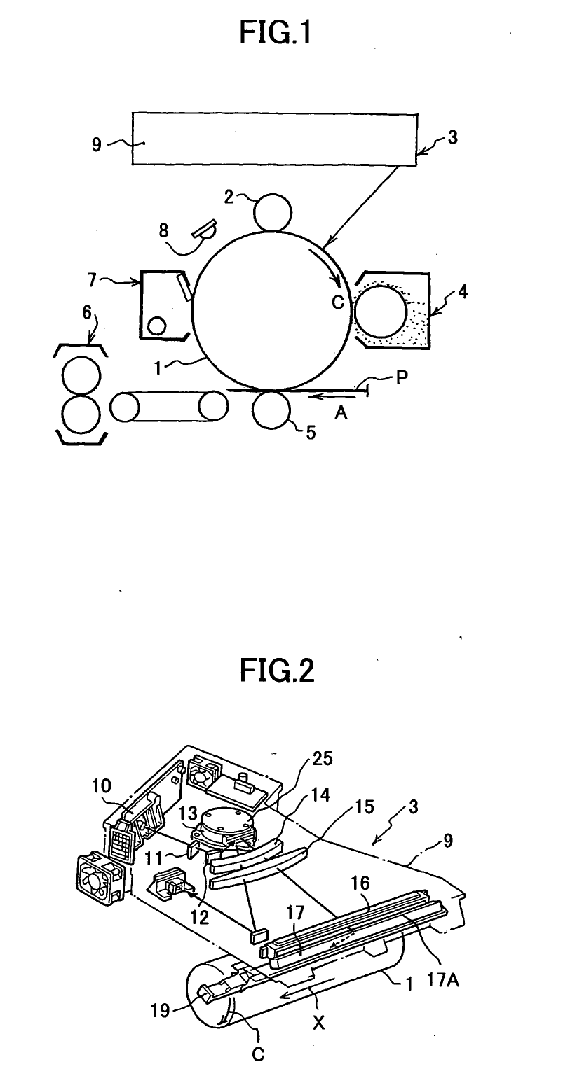

A description of the present invention and details of drawbacks of the related art are now given, with reference to FIG. 1 through FIG. 9, including embodiments of the present invention.

FIG. 1 is a partial cross-sectional schematic view of an example of an image forming device of the present invention. The image forming device as shown in FIG. 1 has a photosensitive body 1 formed in a drum shape. The photosensitive body 1 is rotationally driven clockwise so that a surface of the photosensitive body 1 is moved in the direction shown by arrow C. At this time, the circumferential surface of the photosensitive body 1 is electrostatically charged to a designated polarity, a minus polarity in this example, by an electrostatic charge device 2. The electrostatically charged photosensitive body surface is image-exposed by a light exposure device 3 so that an electrostatic latent image is formed on the photosensitive body 1. This electrostatic latent image is made visible as a toner image by a developing device 4. The toner image is transferred to a transfer material P fed in the direction shown by arrow A from a feeder not shown in FIG. 1, by a transfer device 5. The transfer material P where the toner image is transferred is moved to an adhesive device 6. At this time, heat and pressure are applied to the toner image so that the toner image is adhered on the transfer material P. Toner adhered on the photosensitive body surface after the toner image is transferred is removed by a cleaning device 7. Antistatic light from an antistatic lamp 8 is irradiated on the photosensitive surface, which has been cleaned so that a surface electrostatic potential of the photosensitive body is initialized.

In the example shown in FIG. 1, the toner image formed on the photosensitive body is directly transferred to a final transfer material P. However, the toner image formed on the photosensitive body may be transferred to a transfer material formed by an intermediate transfer body so that the toner on the intermediate transfer body may be transferred to the final transfer material.

FIG. 2 is a schematic view of the light exposure device 3 shown in FIG. 1. A casing 9 of the light exposure device 3 is shown by one-dotted lines and the internal structure thereof is shown. The light exposure device 3 has a laser device 10 using a laser diode. A light beam, a laser beam in this example, out-going from the laser device 10 goes through a cylinder lens 11 and is reflected by a first mirror 12. The light beam is further reflected by a mirror surface of the polygon mirror (See FIG. 4) not shown in FIG. 2 received in a case 13 and then goes through fθ lenses 14 and 15 and a BTL lens 16 and is reflected by a second mirror 17 and a third mirror 17A. The light further out-goes to outside of the casing 9 through a dust-proof glass 19 so as to be irradiated on a surface of the photosensitive body 1 moving in a direction shown by arrow C.

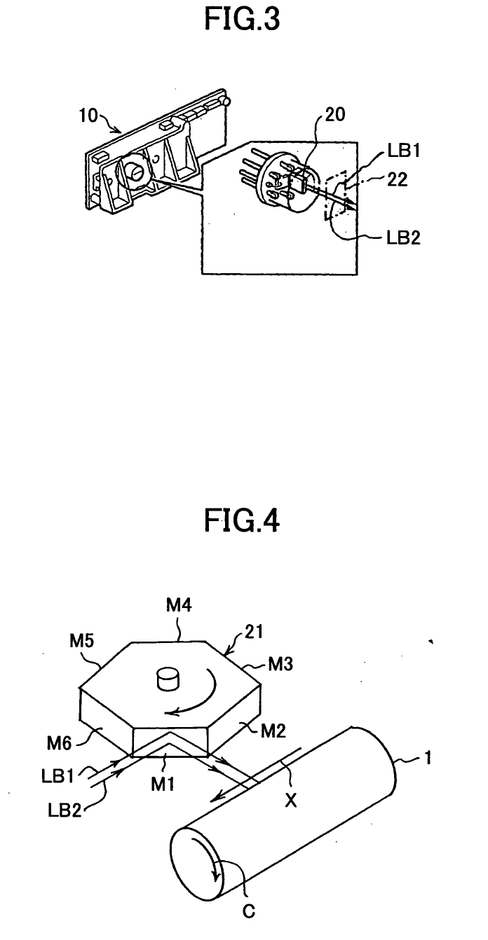

FIG. 3 is an enlarged perspective view of the laser device 10. The laser device 10 includes a laser diode (LD) array 20 where plural light sources formed by laser diodes are arranged in an array shape. Light beams are out-go (are emitted) from respective light sources. In this example, two light sources, namely first and second light sources, are provided. Light beams LB1 and LB2 out-go from respective light sources.

FIG. 4 is a view for explaining a positional relationship between a polygon mirror 21 and the photosensitive body 1. The polygon mirror 21 has a hexagonal configuration having six mirrors, namely first through sixth mirrors M1 through M6. The polygon mirror 21 is rotated in the direction shown by arrow B by a driving device formed by a polygon motor 25. The light beams LB1 and LB2 out-going from the light sources of the laser device 10 are reflected on surfaces of the mirrors of the rotating polygon mirror 21 so as to irradiate on the surface of the photosensitive body 1 moving in the direction shown by arrow C. Thus, the light exposure device 3 of this example has the laser device 10, the polygon mirror 21, and the driving device. The laser device 10 has plural light sources emitting the light beams LB1 and LB2. The polygon mirror 21 has plural mirror M1 through M6 whereby the light beams LB1 and LB2 out-going from the light sources are reflected. The polygon mirror 21 is rotated by the driving device. In the light exposure device 3, corresponding to image data, the light beams LB1 and LB2 out-going from the light source of the laser device 10 and reflected by the mirrors M1 through M6 of the polygon mirror 21 are selectively irradiated on the surface of the moving photosensitive body 1 in a main scanning direction X, so that main scanning whereby beam spots are formed on the photosensitive body surface is performed in order. The main scanning is performed in a sub scanning direction in order so that the electrostatic latent image is formed on the photosensitive body.

FIG. 5-(a) and FIG. 5-(b) are views for explaining an example when the beam spot is formed on the surface of the photosensitive body 1 moving in the direction shown by arrow C. As shown in FIG. 5-(a), the beam spots BS1 and BS2, in order, are formed in a main scanning direction X on the electrostatically charged photosensitive body surface by the light beams LB1 and LB2 reflected by the same mirror of the polygon mirror 21 shown in FIG. 4. Thus, the electrostatic latent image is formed on the photosensitive body surface and the electrostatic latent image is made visible as the toner image. A sign “Y” in FIG. 5 represents the sub scanning direction.

On the other hand, in the example shown in FIG. 5-(b), the light beam LB2 out-going from the second light source of the laser device 10 is reflected on a surface of a mirror such as the first mirror M1 of the polygon mirror 21. By the light beam LB2, the beam spot BS2, in order, is formed in the main scanning direction X on the electrostatically charged photosensitive body surface. Then, the light beam LB1 out-going from the first light source of the laser device 10 is reflected by a next mirror such as the second mirror M2 of the polygon mirror 21. By the light beam LB1, the beam spot BS1, in order, is formed in the main scanning direction X on the electrostatically charged photosensitive body surface. The electrostatic latent image is formed by the beam spots BS2 and BS1 and made visible as the toner image.

As described above, the light exposure device 3 of this example selectively irradiates the light beam on the surface of the photosensitive body 1 corresponding to image data, so that the beam spot is formed on the surface of the photosensitive body. At this time, as shown in FIG. 5-(a) and FIG. 5-(b), parts of the beam spots BS1 and BS2 neighboring each other in the sub scanning direction Y overlap. This overlapped part is shown by cross-hatching in FIG. 5.

In the example shown in FIG. 5-(a), two beam spots BS1 and BS2 neighboring each other in the sub scanning direction Y are simultaneously formed on the photosensitive body surface by two light beams LB1 and LB2 simultaneously reflected on the same mirror surface of the polygon mirror 21. In the example shown in FIG. 5-(b), two beam spots BS1 and BS2 neighboring each other in the sub scanning direction Y are formed by two light beams LB1 and LB2 reflected on the different mirror surfaces of the polygon mirror 21. The two beam spots BS1 and BS2 neighboring each other shown in FIG. 5-(b) are respectively formed on the photosensitive body surface with a time interval. Because of this, in the related art image forming device, in cases where the electrostatic latent images formed by the beam spots as shown in FIG. 5-(a) and FIG. 5-(b) are respectively made visible as toner images, due to the above-mentioned phenomenon of “reciprocal law failure”, image density of the case where the electrostatic latent image formed by the beam spots shown in FIG. 5-(b) is made visible is higher than the image density of the case where the electrostatic latent image formed by the beam spots shown in FIG. 5-(a) is made visible. Hence, in the case where the electrostatic latent image formed by the beam spot shown in FIG. 5-(b) is made visible, density unevenness occurs in the completed toner image.

In the image forming device of the example of the present invention, the summation of light energies when two beam spots neighboring each other are formed on the photosensitive body surface with a time interval, is set to be smaller than the summation of light energies when two beam spots neighboring each other in the sub scanning direction are simultaneously formed on the photosensitive body surface. That is, the summation of light energies formed by the light beams LB2 and LB1 when two beam spots BS2 and BS1 are reflected by different surfaces of the mirror of the polygon mirror 21 as shown in FIG. 5-(b) is set to be smaller than the summation of light energies formed by the light beams LB1 and LB2 when two beam spots BS1 and BS2 are reflected by the same surface of the mirror of the polygon mirror 21 as shown in FIG. 5-(a).

According to the above-discussed structure, the surface electric potential of the photosensitive body when the two beam spots neighboring each other in the sub scanning direction are simultaneously formed on the photosensitive body surface is substantially equal to the surface electric potential of the photosensitive body when the two beam spots neighboring each other in the sub scanning direction are formed on the photosensitive body surface with a time interval. The density unevenness does not occur at the completed toner image, or even if the density unevenness occurs, the degree of the density unevenness becomes small so that the image quality of the toner image is improved. The amount of the light energy when the beam spot is formed can be determined by the amount of the light or the size of the beam spot.

### EXAMPLE 1

Next, details of an example where the amount of the light energy is determined based on the amount of the light by using the above-discussed image forming device is discussed. Image forming conditions are as follows.

The surface electric potential of the photosensitive body after being electrostatically charged is −800 V. The surface electric potential of the photosensitive body after being electrostatically charged in a case where two beam spots neighboring in the sub-scanning direction are simultaneously formed is −100 V. A standard light amount when a beam spot is formed on the photosensitive body surface is 0.44 μJ/cm² and, in this case, areas of the beam spots are the same. Furthermore, 1200 dpi is set as the resolution. As shown in FIG. 5-(a), when the neighboring beam spots BS1 and BS2 are formed by reflecting the light beams LB1 and LB2 on the same mirror surface of the polygon mirror, the LD array 20 is not tilted so that the starting positions of writing of respective beam spots in the main scanning direction X is the same. As shown in FIG. 5-(b), a time interval when the beam spots BS1 and BS2 are formed by reflecting the light beams LB1 and LB2 on the different mirror surfaces of the polygon mirror 21 is approximately 1/4000 sec. The rate of rotation of the polygon mirror 21 is 40000 rpm.

Under the above-mentioned conditions, at the time of the image forming operation, the image formed by the beam spots BS2 and BS1 on the photosensitive body with a time interval is specified by the light beams LB2 and LB1 reflected on the different mirror surfaces of the polygon mirror 21, from a coordinate. When the image is written, the above-mentioned standard light amount is kept as the light amount when the beam spot BS2 is formed and an amount 20% reduced against the standard light amount is set as the light amount when the beam spot BS1 is formed. The standard light amount is kept as the light amount when the beam spots BS1 and BS2 shown in FIG. 5-(a) are formed. Under the above-mentioned structure, it is possible to obtain a high quality image having no density unevenness.

In the above mentioned example, when the beam spots BS2 and BS1 are formed with a time interval, after the beam spot BS2 is formed on the photosensitive body surface by the light beam LB2 reflected by a single mirror of the polygon mirror 21, the light amount when the beam spot BS1 is formed on the photosensitive body surface by the light beam LB1 reflected by the next mirror of the polygon mirror 21 is made small. The light amount when the beam spot BS2 is formed may be made small, or the light amount when the both beam spots BS2 and BS1 are formed may be 10% reduced against the above mentioned standard light amount.

### EXAMPLE 2

An example where the light energy amount is defined by the size of the beam spot is discussed. In this case, as shown in FIG. 5-(a), a standard diameter SR in the main scanning direction of the beam spots BS1 and BS2 formed on the photosensitive body surface by the light beams LB1 and LB2 reflected on the same mirror surface of the polygon mirror 21 is 72 μm. A standard diameter CR in the sub scanning direction of the beam spots BS1 and BS2 formed on the photosensitive body surface by the light beams LB1 and LB2 reflected on the same mirror surface of the polygon mirror 21 is 89 μm. In this case, without changing the light amount when the beam spots are formed, the size of the beam spot is adjusted as shown in the following. Other conditions are the same as the conditions in the Example 1.

Under the above-mentioned conditions, at the time of the image forming operation, the image formed by beam spots BS2 and BS1 on the photosensitive body with a time interval is specified by the light beams LB2 and LB1 reflected on different mirror surfaces of the polygon mirror 21, from a coordinate.

The diameter of the above-mentioned beam spot BS2 when the image is written is kept as the standard diameter and the diameter of the above-mentioned beam spot BS1 is made to be 80% of the standard diameter. A liquid crystal mask 22 shown by the one-dotted line in FIG. 3 is provided at a light beam outgoing opening of the laser device. The area of a light permeation part of the liquid crystal mask 22 is made small by a signal so that the diameter of the beam spot BS1 is reduced and the size of the beam spot BS1 can be made small. Under the above-mentioned structure, it is possible to obtain a high quality image having no density unevenness.

In the above mentioned example, when the beam spots BS2 and BS1 are formed with a time interval, after the beam spot BS2 is formed on the photosensitive body surface by the light beam LB2 reflected by a single mirror of the polygon mirror 21, the size of the beam spot BS1 when the beam spot BS1 is formed on the photosensitive body surface by the light beam LB1 reflected by the next mirror of the polygon mirror 21 is made small. The size of the beam spot BS2 may be made small, or the diameters of both beam spots BS2 and BS1 may be 10% reduced against the standard diameter.

Furthermore, instead of the use of the liquid crystal mask 22, the size of the beam spot may be made small by decreasing the time for forming the beam spot on the photosensitive body (adjustment by the PWM).

In a case where the resolution is smaller than 1200 dpi, such as 600 dpi for example, the phenomenon of the “reciprocal law failure” occurs. However, when the resolution is small, it is difficult to perceive the influence of the phenomenon of the “reciprocal law failure” because the line width of the toner image in a line shape when the electrostatic latent image formed by a one line beam spot formed in the main scanning direction is made visible is primarily wide. Because of this, in the case where the resolution is small, it is acceptable to make the changing amount of the light amount when the beam spot is formed or a changing amount of the diameter of the beam spot small. In addition, the time interval with which two neighboring beam spots are formed is shorter than 1/4000 sec, so the changing amount of the light amount or the diameter of the beam spot may be small.

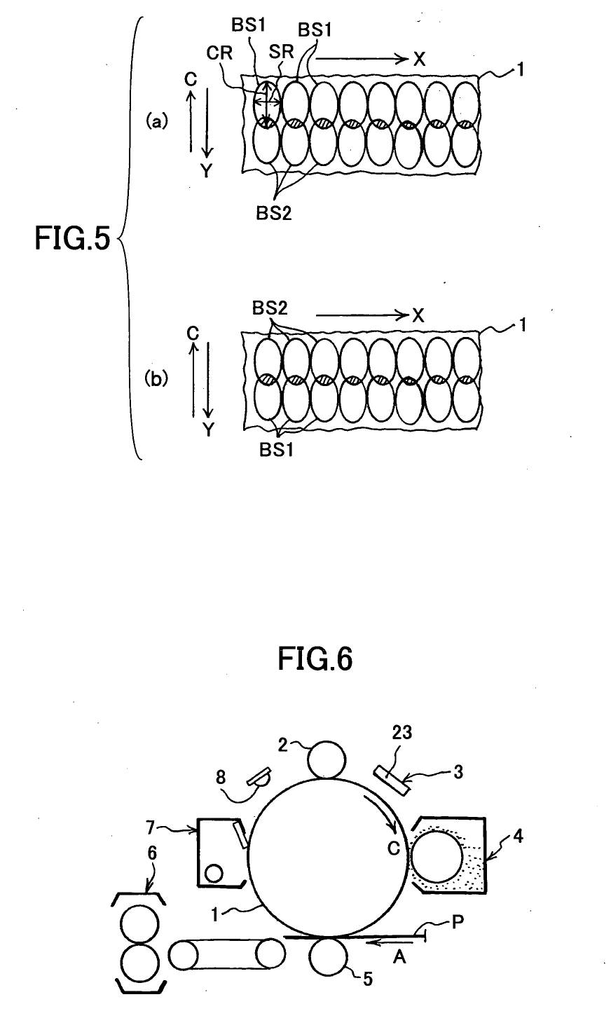

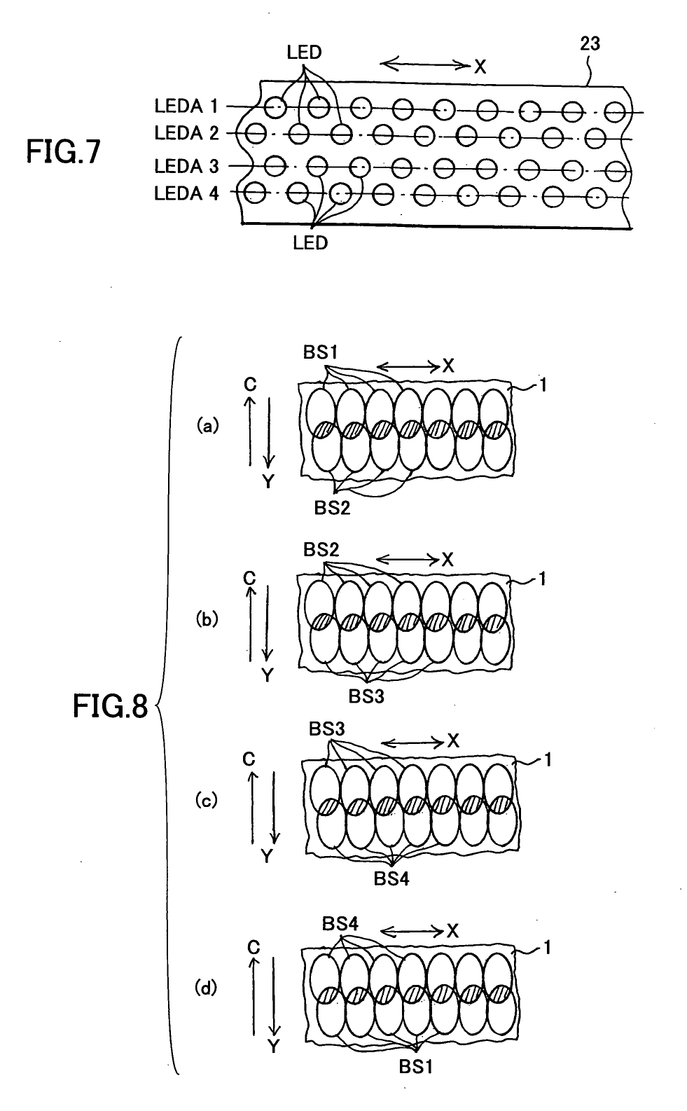

In the image forming device shown in FIG. 6, the light exposure device 3 includes not a laser device but a light emitting diode device 23. FIG. 7 is a view of the light emitting diode device 23 seen from a side of the photosensitive body 1. As shown in FIG. 7, the light emitting diode device 23 includes plural steps of the light emitting diode arrays where a large number of light emitting diodes (LEDs) to form a large number of the beam spots are arranged in a line shape in the main scanning direction X of the photosensitive body surface. In this example, the light emitting diode device 23 includes four steps of light emitting diode arrays LEDA1, LEDA2, LEDA3 and LEDA4. Otherwise, the structure of the image forming device shown in FIG. 6 is the same as the structure of the image forming device shown in FIG. 1. In FIG. 6, parts that are the same as the parts shown in FIG. 1 are given the same reference numerals, and explanation thereof is omitted.

In the image forming device shown in FIG. 6, the photosensitive body surface moving in the direction shown by arrow C is electrostatically charged by the electrostatic charge device 2. The light beam out-going from the light emitting diode LED which emit corresponding to the image data is selectively irradiated on the electrostatically charged photosensitive body surface so that the beam spot is formed on the photosensitive body surface. All of the light emitting diodes LED of first through fourth light emitting diode arrays simultaneously emit corresponding to the image data. By repeating such operations with a time interval, a designated beam spot is formed on the photosensitive body surface so that a surface-shaped electrostatic latent image is formed. The electrostatic latent image is made visible as a toner image by the developing device 4. The toner image is transferred to the transferring material P by the transferring device 5. Other functions of the image forming device shown in FIG. 6 are same as the image forming device shown in FIG. 1.

FIG. 8 shows a state where the beam spot is formed on the photosensitive body surface moving in the direction shown by arrow C. As well as the case shown in FIG. 5, two beam spots neighboring in the sub scanning direction Y are shown in FIG. 8.

More specifically, FIG. 8-(a) shows the beam spots BS1 and BS2 formed on the photosensitive body surface by the emission of the light emitting diodes LED of the light emitting diode arrays LEDA1 and LEDA2 of the first and second steps of the light emitting diode device 23 shown in FIG. 7. FIG. 8-(b) shows the beam spots BS2 and BS3 formed on the photosensitive body surface by the emission of the light emitting diode LED of the light emitting diode array LEDA2 and LEDA3 of the second and third steps of the light emitting diode device 23 shown in FIG. 7. FIG. 8-(c) shows the beam spots BS3 and BS4 formed on the photosensitive body surface by the emission of the light emitting diodes LED of the light emitting diode arrays LEDA3 and LEDA4 of the third and fourth steps of the light emitting diode device 23 shown in FIG. 7. FIG. 8-(d) shows the beam spots BS4 and BS1 formed on the photosensitive body surface by the emission of the light emitting diodes LED of the light emitting diode arrays LEDA4 and LEDA1 of the fourth and first steps of the light emitting diode device 23 shown in FIG. 7.

As shown by cross-hatching in FIG. 8, parts of the two beam spots neighboring each other in the sub scanning direction Y overlap each other in the sub scanning direction Y. Two beam spots neighboring each other in the sub scanning direction Y shown in FIG. 8-(a), FIG. 8-(b) and FIG. 8-(c) are simultaneously formed on the photosensitive body surface. Two beam spots BS4 and BS1 neighboring each other in the sub scanning direction Y shown in FIG. 8-(d) are formed with a time interval. From a coordinate, the image formed by the two beam spots neighboring each other in the sub scanning direction Y with a time interval is specified. The summation of light energies when two beam spots neighboring each other are respectively formed on the photosensitive body surface with a time interval is set to be smaller than the summation of light energies when two beam spots neighboring each other in the sub scanning direction are simultaneously formed on the photosensitive body surface. Because of this, density unevenness in the toner image formed on the photosensitive body 1 can be prevented.

In the above mentioned example, whether two beam spots neighboring in the sub scanning direction Y are formed on the photosensitive body surface with a time interval is determined from the coordinate so that the summation of the light energies when the two beam spots are formed is controlled to be made small. However, the control structure may be complex and therefore the cost for manufacturing the image forming device may rise. In an image forming device having the following structure, the control structure can be simplified and the cost for manufacturing the image forming device can be reduced.

The image forming device shown in FIG. 1 through FIG. 4 has the laser device 10 having two light sources. In a case where the laser device has more than N (N is an integer greater than 3) light sources arranged in a line shape, the amount of light energy when beam spots are formed on the photosensitive body surface by light beams out-going from the first light source and the Nth light source is set to be always smaller than the amount of a light energy when a beam spot is formed on the photosensitive body surface by a light beam out-going from other light sources. Details of setting this are as follows.

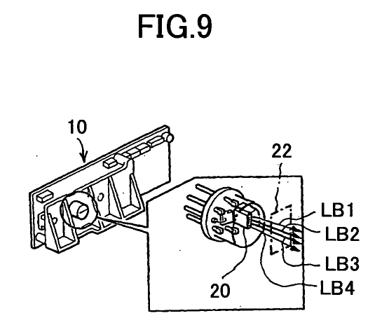

The laser device 10 shown in FIG. 9 has an LED array 20 formed by an arrangement in an array shape of four light sources formed by laser diodes. The light beams LB1, LB2, LB3 and LB4 respectively out-go from the light sources. As well as in the image forming device shown in FIG. 1 through FIG. 4, the respective light beams are reflected on the mirror surface of the polygon mirror 21 and irradiated on the photosensitive body surface moving in the direction shown by arrow C so that the beam spot is formed on the photosensitive body surface. There are two cases, namely a case where two beam spots BS1, BS2; BS2, BS3; or BS3, BS4 are simultaneously formed on the photosensitive body surface by the optical beams LB1, LB2; LB2, LB3; or LB3, LB4, reflected on the same mirror surface as in the cases shown in FIG. 8-(a), FIG. 8-(b) and FIG. 8-(c), and a case where two beam spots BS4, BS1 are formed on the photosensitive body surface by the optical beams LB4, LB1, reflected on the different mirrors as in the case shown in FIG. 8-(d) with a time interval. Therefore, by setting the amount of light energy when beam spots are formed on the photosensitive body surface by light beams LB1 and LB4 out-going from the first and fourth light sources to be always smaller than the amount of a light energy when the beam spot is formed on the photosensitive body surface by the light beam LB2 and LB3 out-going from other light sources, it is possible to reduce the occurrence of density unevenness of the completed toner image. Thus, it is possible to improve image quality of the completed toner image by simplifying the control structure.

### EXAMPLE 3

The image forming device having the laser devices shown in FIG. 9 which has four light sources is discussed.

The diameter in the sub scanning direction of the beam spot formed on the photosensitive body is 70 μm and the diameter in the main scanning direction of the beam spot formed on the photosensitive body is 55 μm. The light amount when the beam spots BS1 and BS4 are formed on the photosensitive body surface by the light beams LB1 and LB4 are fixed to −10% against the standard light amount 0.44 μJ/cm². On the other hand, the light amount when the beam spots BS2 and BS3 are formed on the photosensitive body surface by the light beams LB2 and LB3 are fixed to +10% against the standard light amount 0.44 μJ/cm . Other conditions for making the image are the same as the conditions in the Example 1.

The diameters of the toner image formed by making visible the electrostatic latent image formed by two beam spots neighboring in the sub scanning direction before and after the light amount is changed are as follows.

1) Beam spots “BS1, BS2” and “BS3, BS4”;
Before the light amount is changed: approximately 85 μm→
After the light amount is changed: approximately 85 μm

2) Beam spots “BS2, BS3”;
Before the light amount is changed: approximately 85 μm→
After the light amount is changed: approximately 90 μm

3) Beam spots “BS4, BS1”;
Before the light amount is changed: approximately 100 μm
After the light amount is changed: approximately 93 μm

### EXAMPLE 4

In this example, the sizes of the beam spots BS1 and BS4 formed on the photosensitive body by the light beam out-going from the laser device 10 shown in FIG. 9 are made small and the sizes of the beam spots BS2 and BS3 are made large. That is, the diameter in the sub scanning direction of the beam spot BS1 or BS4 is 65 μm, the diameter in the main scanning direction of the beam spot BS1 or BS4 is 52 μm, the diameter in the sub scanning direction of the beam spot BS2 or BS3 is 75 μm, and the diameter in the main scanning direction of the beam spot BS2 or BS3 is 58 μm. Other conditions are same as the conditions in Example 2. By the image forming device in this example, it is possible to form the toner image the same as the one in Example 3.

Like the image forming device shown in FIG. 6 and FIG. 7, in a case where a light emitting diode device is used as the light exposure device 3, when the light emitting diode device 23 has more than N (N is an integer greater than 3) light diode arrays, the amount of light energy when beam spots are formed on the photosensitive body surface by light beams out-going from the first light emitting diode array and the Nth light emitting diode array is set to be always smaller than the amount of light energy when a beam spot is formed on the photosensitive body surface by a light beam out-going from other light emitting diode arrays. As a result of this, the control is simplified and it is possible to form the toner image having high quality whereby the occurrence of density unevenness can be prevented.

### EXAMPLE 5

In this example, the light emitting diode device 23 shown in FIG. 6 and FIG. 7 is used. The diameter in the sub scanning direction of the beam spot formed on the photosensitive body is 70 μm and the diameter in the main scanning direction of the beam spot formed on the photosensitive body is 55 μm. The light amount when the beam spots BS1 and BS4 are formed on the photosensitive body surface by the light beams out-going from the light emitting diode arrays LEDA1 and LEDA4 is fixed to −10% against the standard light amount. On the other hand, the light amount when the beam spots BS2 and BS3 are formed on the photosensitive body surface by the light beams out-going from the light emitting diode arrays LEAD1 and LEAD4 is fixed to +10% against the standard light amount. Other conditions for making the image are the same as the conditions in Example 3. By using the image forming device of this example, it is possible to form the toner image the same as the one in Example 3.

### EXAMPLE 6

Details of other examples using the light emitting diode device 23 shown in FIG. 6 and FIG. 7 are discussed.

The diameter in the sub scanning direction of the beam spots BS1 and BS4 formed on the photosensitive body surface by the light beams out-going from the light emitting diodes LED of the first and fourth light emitting diode arrays LEDA1 and LEDA4 is 65 μm, and the diameter in the main scanning direction of the beam spots BS1 and BS4 formed on the photosensitive body surface by the light beams out-going from the light emitting diodes LED of the first and fourth light emitting diode arrays LEDA1 and LEDA4 is 52 μm. The diameter in the sub scanning direction of the beam spots BS2 and BS3 formed on the photosensitive body surface by the light beams out-going from the light emitting diodes LED of the second and third light emitting diode arrays LEDA2 and LEDA3 is 75 μm, and the diameter in the main scanning direction of the beam spots BS2 and BS3 formed on the photosensitive body surface by the light beams out-going from the light emitting diodes LED of the second and third light emitting diode arrays LEDA2 and LEDA3 is 58 μm. Other conditions are the same as the conditions in Example 5. By the image forming device in this example, it is possible to form the toner image the same as the one in Example 3.

As shown in the Examples 3 through 6, in a case where the diameter of the beam spot is reduced or the light amount for forming the beam spot is reduced, when the size of another beam spot is made large by the above-mentioned reduced size, or the light amount for forming another beam spot is increased by the above-mentioned reduced light amount, degradation of the image quality due to the insufficiency of the light amount or insufficiency of the beam spot size can be prevented.

When two beam spots neighboring in the sub scanning direction are formed on the photosensitive body surface with a time interval, it is possible to change the time interval. In this case, if summation of the amount of the light energy when two beam spots neighboring in the sub scanning direction are formed on the photosensitive body surface is made lower as the time difference is greater, it is possible to efficiently prevent the occurrence of density unevenness of the completed toner image.

For example, the light exposure device has the light emitting diode device having the light emitting diode array wherein a large number of the light emitting diodes for forming a large number of beam spots on the photosensitive body surface in the main scanning direction are arranged in a line shape. The light beam out-going from the light emitting diode is selectively irradiated on the moving photosensitive body surface, corresponding to the image data, so that the beam spot is formed on the photosensitive body surface. This beam spot is formed in a state where parts of two beam spots neighboring each other on the photosensitive body surface in the sub scanning direction overlap each other in the sub scanning direction. In this case, light emitting timing of the light emitting diodes of the light emitting diode array can be adjusted so that the time interval when two beam spots are formed on the photosensitive body surface can be changed. Because of this, it is possible to change the time interval when two beam spots neighboring in the sub-scanning direction are formed with the time interval.

Thus, according to the present invention, it is possible to effectively prevent the occurrence of density unevenness of the toner image with a simple structure.

The present invention is not limited to the above-discussed embodiments, but variations and modifications may be made without departing from the scope of the present invention.

This patent application is based on Japanese Priority Patent Application No. 2004-19820 filed on Jan. 28, 2004, the entire contents of which are hereby incorporated by reference.

1. An image forming device, comprising:
a photosensitive body;
an electrostatic charging device which electrostatically charges the photosensitive body;
a light exposure device which image-light-exposes a moving surface of the photosensitive body so that an electrostatic latent image is formed on the photosensitive body; and
a developing device which makes visible the electrostatic latent image as a toner image;
wherein the light exposure device forms a beam spot on the moving surface of the photosensitive body by selectively irradiating a light beam corresponding to image data in a state where parts of two beam spots neighboring each other in a sub scanning direction overlap each other in the sub scanning direction, and
a summation of light energies when the two beam spots are formed on the surface of the photosensitive body with a time interval is set to be smaller than a summation of light energies when two beam spots are simultaneously formed on the surface of the photosensitive body.

2. The image forming device as claimed in claim 1,
wherein an amount of the light energy when the beam spot is formed is determined by an amount of the light.

3. The image forming device as claimed in claim 1,
wherein an amount of the light energy when the beam spot is formed is determined by a size of the beam spot.

4. An image forming device, comprising:
a photosensitive body;
an electrostatic charging device which electrostatically charges the photosensitive body;
a light exposure device which image-light-exposes a moving surface of the photosensitive body so that an electrostatic latent image is formed on the photosensitive body; and
a developing device which makes visible the electrostatic latent image as a toner image;
wherein the light exposure device includes:
a laser device having a plurality of light sources which respectively irradiate light beams;
a polygon mirror having a plurality of mirrors which reflects the light beam out-going from the light source; and
a driving device which rotates the polygon mirror;
wherein the light exposure device main-scans in order to form a beam spot on the moving surface of the photosensitive body by selectively irradiating, in a main scanning direction, a light beam which out-goes from the light source and which is reflected by the mirror of the polygon mirror, corresponding to image data, in a state where parts of two beam spots neighboring each other in a sub scanning direction overlap each other in the sub scanning direction, and
wherein a summation of light energies when the two beam spots are formed by the light beams reflected by different mirror surfaces of the polygon mirror is set to be smaller than a summation of light energies when the two beam spots are formed by the light beams simultaneously reflected by the same mirror surface of the polygon mirror.

5. The image forming device as claimed in claim 4,
wherein the laser device has more than N light sources arranged in a line shape when N is an integer more than 3, and an amount of light energy when beam spots are formed on the photosensitive body surface by light beams out-going from the first light source and the Nth light source is set to be always smaller than an amount of a light energy when a beam spot is formed on the photosensitive body surface by a light beam out-going from another light source.

6. The image forming device as claimed in claim 4,
wherein an amount of the light energy when the beam spot is formed is determined by an amount of the light.

7. The image forming device as claimed in claim 4,
wherein an amount of the light energy when the beam spot is formed is determined by a size of the beam spot.

8. An image forming device, comprising:
a photosensitive body;
an electrostatic charging device which electrostatically charges the photosensitive body;
a light exposure device which image-light-exposes a moving surface of the photosensitive body so that an electrostatic latent image is formed on the photosensitive body; and
a developing device which makes visible the electrostatic latent image as a toner image;
wherein the light exposure device has a light emitting diode device including a plurality of steps of light emitting diode arrays where light emitting diodes to form the beam spots are arranged in a line shape in a main scanning direction of the photosensitive body surface,
wherein the light exposure device forms a beam spot on the moving surface of the photosensitive body by selectively irradiating a light beam corresponding to image data in a state where parts of two beam spots neighboring each other in a sub scanning direction overlap each other in the sub scanning direction, and
wherein a summation of light energies when the two beam spots are formed on the surface of the photosensitive body with a time interval is set to be smaller than a summation of light energies when two beam spots are simultaneously formed on the surface of the photosensitive body surface.

9. The image forming device as claimed in claim 8,
wherein the light emitting device has more than N light emitting diode arrays arranged in a line shape when N is an integer more than 3, and an amount of light energy when beam spots are formed on the photosensitive body surface by light beams out-going from the light emitting diodes of the first light emitting diode array and the Nth light emitting diode array is set to be always smaller than an amount of light energy when a beam spot is formed on the photosensitive body surface by a light beam out-going from light emitting diodes of another light emitting diode array.

10. The image forming device as claimed in claim 8,
wherein an amount of the light energy when the beam spot is formed is determined by a size of the beam spot.

11. An image forming device, comprising:
a photosensitive body;
an electrostatic charging device which electrostatically charges the photosensitive body;
a light exposure device which image-light-exposes a moving surface of the photosensitive body so that an electrostatic latent image is formed on the photosensitive body; and
a developing device which makes visible the electrostatic latent image as a toner image;
wherein the light exposure device forms a beam spot on the moving surface of the photosensitive body by selectively irradiating a light beam corresponding to image data in a state where parts of two beam spots neighboring each other in a sub scanning direction overlap each other in the sub scanning direction, and
a summation of the amount of the light energy when two beam spots neighboring in the sub scanning direction are formed on the surface of the photosensitive body is made lower, as a time difference with which the two beam spots ate formed on the surface of the photosensitive body is larger.

12. The image forming device as claimed in claim 11,
wherein the light exposure device has a light emitting diode device including a plurality of steps of light emitting diode arrays where light emitting diodes to form the beam spots are arranged in a line shape in a main scanning direction of the photosensitive body surface,
wherein the light exposure device forms a beam spot on the moving surface of the photosensitive body by selectively irradiating a light beam corresponding to image data in a state where parts of two beam spots neighboring each other in a sub scanning direction overlap each other in the sub scanning direction, and
wherein light emitting timing of the light emitting diode is adjustable so that the time interval when two beam spots are formed on the photosensitive body surface is changeable.

13. The image forming device as claimed in claim 11,
wherein an amount of the light energy when the beam spot is formed is determined by an amount of the light.

14. The image forming device as claimed in claim 11,
wherein an amount of the light energy when the beam spot is formed is determined by a size of the beam spot.
